(19) United States
(12) Patent Application Publication
(10) Pub. No.: US 2026/0036052 A1
(43) Pub. Date: Feb. 5, 2026

(54) IMPELLER SPLITTER BACKSWEEP

(71) Applicant: Pratt & Whitney Canada Corp., Longueuil (CA)

(72) Inventors: Hien Duong, Mississauga (CA); Jason Nichols, Mississauga (CA)

(21) Appl. No.: 18/793,229

(22) Filed: Aug. 2, 2024

(51) Int. Cl. F01D 5/14; F04D 17/10; F04D 29/28

(52) U.S. Cl. CPC F01D 5/141; F04D 17/10; F04D 29/284; F05D 2220/323; F05D 2240/304

(57) ABSTRACT

A centrifugal compressor of an aircraft gas turbine engine includes an impeller having a hub, main and splitter vanes, and a shroud surrounding the hub and the main and splitter vanes to form a flow path from an inducer portion at an upstream side of the impeller to an exducer portion at an impeller exit. The main vanes extend from the inducer portion to the exducer portion and the splitter vanes are interleaved with the main vanes and extend to the exducer portion from an impeller mid-point. Each main and splitter vane includes, at the impeller exit, a trailing edge, and, for one or more pairs of main and splitter vanes the trailing edge of the splitter vane exhibits backsweep of a first degree, and the trailing edge of the main vane exhibits backsweep of a second degree.

### BACKGROUND

Exemplary embodiments of the present disclosure relate generally to impellers and, in some embodiments, to an impeller of a centrifugal compressor of a gas turbine engine of an aircraft engine with impeller splitter backsweep.

Centrifugal compressors are widely used in aerospace and industrial applications. An impeller of a centrifugal compressor can generate large increases in the total pressure of a working fluid by way of a radius change from the inlet of the impeller to the exit of the impeller. A diffuser is typically arranged downstream from the exit of the impeller and is used to convert kinetic energy from the impeller in the form of a velocity of the working fluid to potential energy in the form of static pressure of the working fluid. Diffuser performance is often strongly affected by impeller exit conditions.

Accordingly, a continuing need exists for improvements in centrifugal compressors that exhibit improved impeller exit conditions and thus improved diffuser performance.

### BRIEF DESCRIPTION

According to a non-limiting embodiment, a centrifugal compressor of an aircraft gas turbine engine comprises an impeller including a hub, main and splitter vanes, and a shroud surrounding the hub and the main and splitter vanes to form a flow path from an inducer portion at an upstream side of the impeller to an exducer portion at an impeller exit. The main vanes extend from the inducer portion to the exducer portion and the splitter vanes are interleaved with the main vanes and extend to the exducer portion from an impeller mid-point. Each main and splitter vane comprises, at the impeller exit, a trailing edge, and, for one or more pairs of main and splitter vanes the trailing edge of the splitter vane exhibits backsweep of a first degree, and the trailing edge of the main vane exhibits backsweep of a second degree.

In addition to one or more of the features described above, or as an alternative to any of the foregoing embodiments, the impeller mid-point is defined as an impeller knee, which is interposed between the inducer and exducer portions.

In addition to one or more of the features described above, or as an alternative to any of the foregoing embodiments, the trailing edge of the main vane of the one or more pairs of main and splitter vanes comprises a hub-side trailing edge portion, which is adjacent to the hub, a shroud-side trailing edge portion, which is displaced from the shroud, and a central trailing edge portion interposed between the hub-side trailing edge portion and the shroud-side trailing edge portion. The trailing edge of the splitter vane of the one or more pairs of main and splitter vanes comprises a hub-side trailing edge portion, which is adjacent to the hub, a shroud-side trailing edge portion, which is displaced from the shroud, and a central trailing edge portion interposed between the hub-side trailing edge portion and the shroud-side trailing edge portion.

In addition to one or more of the features described above, or as an alternative to any of the foregoing embodiments, the trailing edge of the main vane of the one or more pairs of main and splitter vanes exhibits a same backsweep at the hub-side trailing edge portion and at the shroud-side trailing edge portion. The trailing edge of the splitter vane of the one or more pairs of main and splitter vanes exhibits a same backsweep at the hub-side trailing edge portion and at the shroud-side trailing edge portion.

In addition to one or more of the features described above, or as an alternative to any of the foregoing embodiments, for the one or more pairs of main and splitter vanes, the backsweep of the first degree exhibited by the trailing edge of the splitter vane differs from the backsweep of the second degree exhibited by the trailing edge of the main vane by about 5 degrees.

In addition to one or more of the features described above, or as an alternative to any of the foregoing embodiments, for the one or more pairs of main and splitter vanes, the backsweep of the first degree exhibited by the trailing edge of the splitter vane exceeds the backsweep of the second degree exhibited by the trailing edge of the main vane.

In addition to one or more of the features described above, or as an alternative to any of the foregoing embodiments, for the one or more pairs of main and splitter vanes: an angle of the backsweep of the first degree exhibited by the trailing edge of the splitter vane is about −25 degrees; and an angle of the backsweep of the second degree exhibited by the trailing edge of the main vane is about −20 degrees.

In addition to one or more of the features described above, or as an alternative to any of the foregoing embodiments, for the one or more pairs of main and splitter vanes, the backsweep of the first degree exhibited by the trailing edge of the splitter vane exceeds the backsweep of the second degree exhibited by the trailing edge of the main vane from about 50%-70% chord to 100% chord.

In addition to one or more of the features described above, or as an alternative to any of the foregoing embodiments, for the one or more pairs of main and splitter vanes, the backsweep of the first degree exhibited by the trailing edge of the splitter vane is variable from one splitter vane to another.

According to another non-limiting embodiment, a centrifugal compressor of an aircraft gas turbine engine comprises an impeller comprising a hub, main and splitter vanes, and a shroud surrounding the hub and the main and splitter vanes to form a flow path from an inducer portion at an upstream side of the impeller to an exducer portion at an impeller exit. The main vanes extend from the inducer portion to the exducer portion and the splitter vanes are interleaved with the main vanes and extend to the exducer portion from an impeller mid-point. Each main and splitter vane comprises, at the impeller exit, a trailing edge. The trailing edges of the splitter vanes exhibit backsweep of a first degree, and the trailing edges of the main vanes exhibit backsweep of a second degree.

In addition to one or more of the features described above, or as an alternative to any of the foregoing embodiments, the impeller mid-point is defined as an impeller knee, which is interposed between the inducer and exducer portions.

In addition to one or more of the features described above, or as an alternative to any of the foregoing embodiments, each of the trailing edges of the main vanes comprises a hub-side trailing edge portion, which is adjacent to the hub, a shroud-side trailing edge portion, which is displaced from the shroud, and a central trailing edge portion interposed between the hub-side trailing edge portion and the shroud-side trailing edge portion. Each of the trailing edges of the splitter vane comprises a hub-side trailing edge portion, which is adjacent to the hub, a shroud-side trailing edge portion, which is displaced from the shroud, and a central trailing edge portion interposed between the hub-side trailing edge portion and the shroud-side trailing edge portion.

In addition to one or more of the features described above, or as an alternative to any of the foregoing embodiments, each of the trailing edges of the main vanes exhibits a same backsweep at the hub-side trailing edge portion and at the shroud-side trailing edge portion. Each of the trailing edges of the splitter vanes exhibits a same backsweep at the hub-side trailing edge portion and at the shroud-side trailing edge portion.

In addition to one or more of the features described above, or as an alternative to any of the foregoing embodiments, the backsweep of the first degree exhibited by the trailing edges of the splitter vanes differs from the backsweep of the second degree exhibited by the trailing edges of the main vanes by about 5 degrees.

In addition to one or more of the features described above, or as an alternative to any of the foregoing embodiments, the backsweep of the first degree exhibited by the trailing edges of the splitter vanes exceeds the backsweep of the second degree exhibited by the trailing edges of the main vanes.

In addition to one or more of the features described above, or as an alternative to any of the foregoing embodiments, an angle of the backsweep of the first degree exhibited by the trailing edges of the splitter vanes is about −25 degrees, and an angle of the backsweep of the second degree exhibited by the trailing edges of the main vanes is about −20 degrees.

In addition to one or more of the features described above, or as an alternative to any of the foregoing embodiments, the backsweep of the first degree exhibited by the trailing edges of the splitter vanes exceeds the backsweep of the second degree exhibited by the trailing edges of the main vanes from about 50%-70% chord to 100% chord.

In addition to one or more of the features described above, or as an alternative to any of the foregoing embodiments, the backsweep of the first degree exhibited by the trailing edges of the splitter vanes is variable from one splitter vane to another.

According to yet another non-limiting embodiment, an impeller of a centrifugal compressor of an aircraft gas turbine engine comprises a hub, main vanes, splitter vanes, and a shroud surrounding the hub and the main and splitter vanes to form a flow path from an inducer portion at an upstream side of the impeller to an exducer portion at an impeller exit. The main vanes extend from the inducer portion to the exducer portion and the splitter vanes are interleaved with the main vanes and extend to the exducer portion from an impeller mid-point. Each main and splitter vane comprises, at the impeller exit, a trailing edge, and, for one or more pairs of main and splitter vanes, the trailing edge of the splitter vane exhibits greater backsweep than the trailing edge of the main vane.

In addition to one or more of the features described above, or as an alternative to any of the foregoing embodiments, each of the trailing edges of each of the splitter vanes exhibits greater backsweep than each of the trailing edges of each of the main vanes.

These and other advantages and features will become more apparent from the following description taken in conjunction with the drawings.

### BRIEF DESCRIPTION OF THE DRAWINGS

The following descriptions should not be considered limiting in any way. With reference to the accompanying drawings, like elements are numbered alike:

FIG. 1 is a schematic cross-sectional view of a prior art gas turbine engine in accordance with embodiments;

FIG. 2 is a schematic cross-sectional view of a prior art impeller in accordance with embodiments;

FIGS. 3A and 3B are side and perspective views of an impeller of a centrifugal compressor in accordance with embodiments;

FIG. 4 is a graphical illustration of backsweep exhibited by a trailing edge of an impeller main vane at an impeller hub and at an impeller shroud in accordance with embodiments;

FIG. 5 is a graphical illustration of linear and non-linear distributions of backsweep change of a trailing edge of an impeller main vane in accordance with embodiments;

FIGS. 6A and 6B are side and perspective views of an impeller with main and splitter vanes of a centrifugal compressor in accordance with embodiments; and

FIG. 7 is a graphical illustration of backsweep exhibited by trailing edges of impeller main and splitter vanes in accordance with embodiments.

These and other advantages and features will become more apparent from the following description taken in conjunction with the drawings.

### DETAILED DESCRIPTION

A detailed description of one or more embodiments of the disclosed apparatus and method are presented herein by way of exemplification and not limitation with reference to the Figures.

As noted above, centrifugal compressors are widely used in aerospace and industrial applications. An impeller of a centrifugal compressor can generate large increases in the total pressure of a working fluid by way of a radius change from the inlet of the impeller to the exit of the impeller. A diffuser is typically arranged downstream from the exit of the impeller and is used to convert kinetic energy from the impeller in the form of a velocity of the working fluid to potential energy in the form of static pressure of the working fluid. Diffuser performance is often strongly affected by impeller exit conditions. For example, maximum diffusion in the diffuser will occur with smooth inlet profiles. Achieving such smooth inlet profiles can be difficult however for several reasons. These reasons include, but are not limited to, impeller tip clearance between the impeller tip and the shroud, strong curvature in the impeller near the shroud and shock and/or boundary layer interactions.

Accordingly, a continuing need exists for improvements in centrifugal compressors that exhibit improved impeller exit conditions and thus improved diffuser performance.

As will be described below, an impeller of a centrifugal compressor is provided with an adjusted impeller splitter backsweep angle relative to main blades. Whereas, main blades go from the leading edge (entry) of the impeller to the trailing edge, splitter blades are employed to reduce the number of blades at the impeller entry and to open up the area and employ higher choke flow. Splitter blades are usually main blades that start near the knee of the impeller and end at the trailing edge. Higher backsweep of the splitter blades increases the performance of the centrifugal stage on the choke side of the speedline. Additional benefits of a difference in backsweep of main blades and splitter blades can include an ability to intentionally mis-tune the impeller and the diffuser. A difference in main and splitter blade backsweep can be at least about 5 degrees (i.e., where splitter blade backsweep can be more or less than the main blade backsweep depending on conditions).

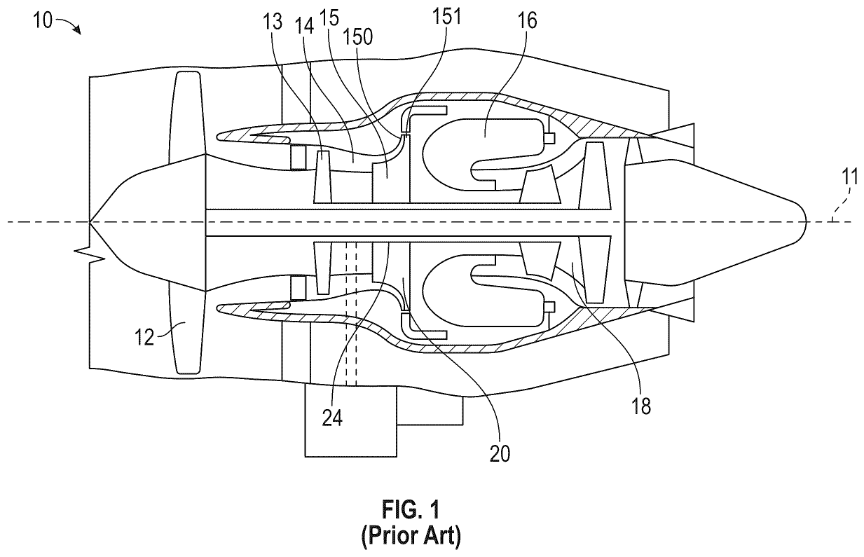

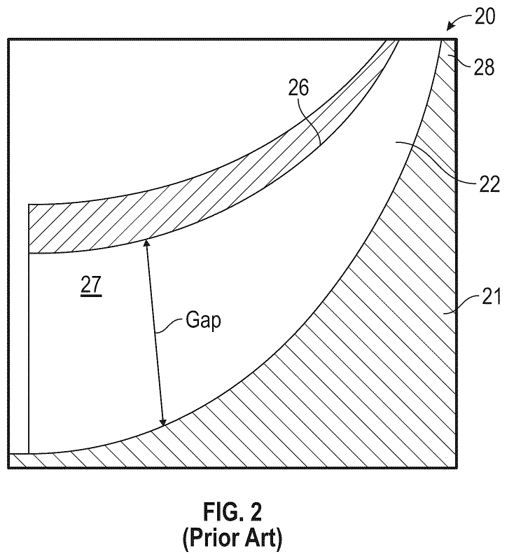

FIGS. 1 and 2 illustrate a prior art turbofan gas turbine engine 10 of a type preferably provided for use in subsonic flight of an aircraft and a prior art impeller 20.

The gas turbine engine 10 generally includes in serial flow communication a fan 12 through which ambient air is propelled, a multistage high-pressure compressor (HPC) 14 for pressurizing the air having an axial compressor 13 and a centrifugal compressor 15, an impeller shroud 150, a diffuser 151, a combustor 16 and a turbine section 18. The impeller shroud 150 is adjacent to the centrifugal compressor 15 and forms a fluid flow path for air being compressed with the centrifugal compressor 15. The diffuser 151 is downstream from the centrifugal compressor 15 and directs compressed air from the centrifugal compressor 15 to the combustor 16. The compressed air is mixed with fuel and ignited is the combustor 16 for generating an annular stream of hot combustion gases. The turbine section 18 is configured to extract energy from the combustion gases. The center axis 11 of the engine 10 is also illustrated.

The centrifugal compressor 15 axially receives a compressible fluid, increases the pressure of the compressible fluid and conveys it in a substantially radial direction. The working or compressible fluid can be any fluid which can experience significant variations in density and in most instances is air or another gas. The centrifugal compressor 15 includes at least an impeller 20, which increases the pressure of the compressible fluid before conveying it downstream and the impeller shroud 150, which houses the impeller 20 and provides structure to the centrifugal compressor 15.

The impeller 20 can be any device which can rotate about a central axis so as to increase the pressure of the compressible fluid. The impeller 20 has an impeller hub 21 and multiple impeller vanes 22 extending from the impeller hub 21. The impeller 20 is mounted to a shaft 24 which rotates, along with the impeller 20, about a shaft axis that can be coaxial with center axis 11. The impeller shroud 150 houses or encloses the impeller 20 and includes a shroud body, which provides the impeller shroud 150 with structure and an ability to resist loads generated by the centrifugal compressor 15 when in operation. The impeller shroud 150 also has a shroud surface 26, which is exposed to the compressible fluid and which surrounds the impeller vanes 22. The shroud surface 26 and the impeller hub 21 respectively extend between an inducer portion 27 and an exducer portion 28.

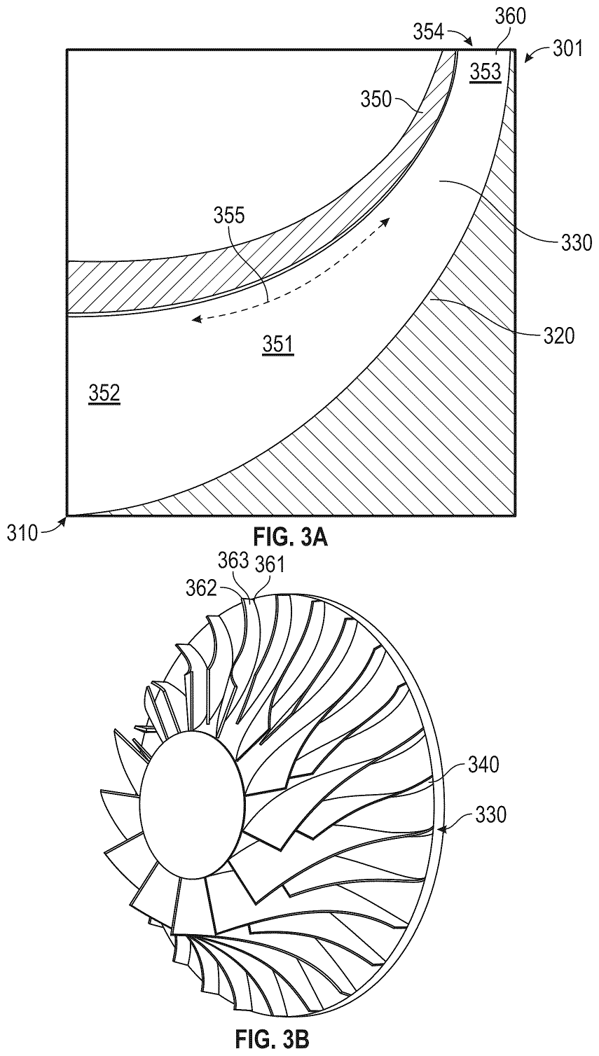

With continued reference to FIGS. 1 and 2 and with additional reference to FIGS. 3A and 3B, a centrifugal compressor 301 of an aircraft gas turbine engine, such as the centrifugal compressor 15 of the gas turbine engine 10 of FIG. 1, is provided. The centrifugal compressor 301 includes an impeller 310. The impeller 310 includes an impeller hub 320, impeller main vanes 330, impeller splitter vanes 340 and an impeller shroud 350. The impeller shroud 350 surrounds the impeller hub 320 and surrounds the impeller main vanes 330 and the impeller splitter vanes 340 to form a flow path 351 from an inducer portion 352 at an upstream side of the impeller 310 to an exducer portion 353 at an impeller exit 354. It is to be understood that the impeller splitter vanes 340 are not required, however, and that embodiments exist in which the impeller 310 includes only impeller main vanes 330. The following description will relate to the cases in which the impeller 310 includes both impeller main vanes 330 and impeller splitter vanes 340 for purposes of clarity and brevity.

The impeller main vanes 330 extend from the inducer portion 352 to the exducer portion 353. The impeller splitter vanes 340 are interleaved with the impeller main vanes 330 and extend to the exducer portion 353 from an impeller mid-point. In accordance with embodiments, the impeller mid-point can be defined as an impeller knee 355, which is interposed between the inducer portion 352 and the exducer portion 353 and which is characterized as being a range of locations where the flow path 351 changes from a predominantly axial direction to a predominantly radial direction.

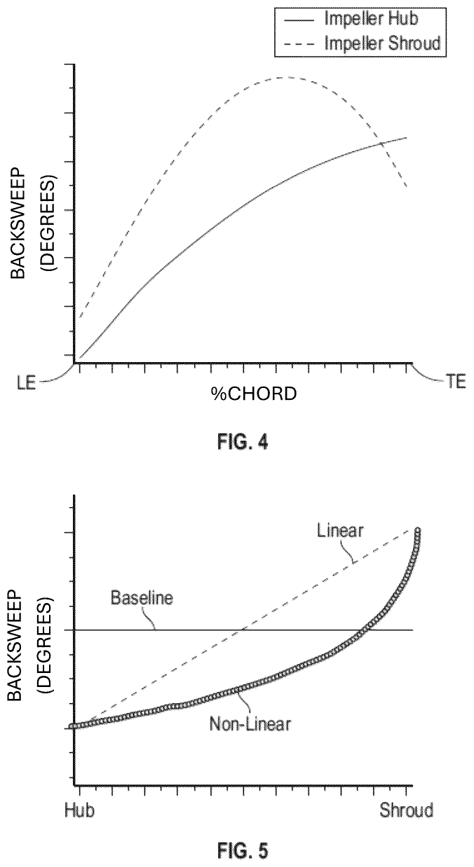

With continued reference to FIGS. 3A and 3B and with additional reference to FIGS. 4 and 5, each of the impeller main vanes 330 includes, at the impeller exit 354, a trailing edge 360. The trailing edge 360 of one or more of the impeller main vanes 330 includes a hub-side trailing edge portion 361, which is proximate or adjacent to the impeller hub 320 and which exhibits backsweep of a first degree, a shroud-side trailing edge portion 362, which is proximate to and displaced from the impeller shroud 350 and which exhibits backsweep of a second degree, and a central trailing edge portion 363 that is interposed between the hub-side trailing edge portion 361 and the shroud-side trailing edge portion 362. In at least one or more cases, the hub-side trailing edge portion 361 exhibits the backsweep of the first degree and the shroud-side trailing edge portion 362 exhibits the backsweep of the second degree for each of the impeller main vanes 330.

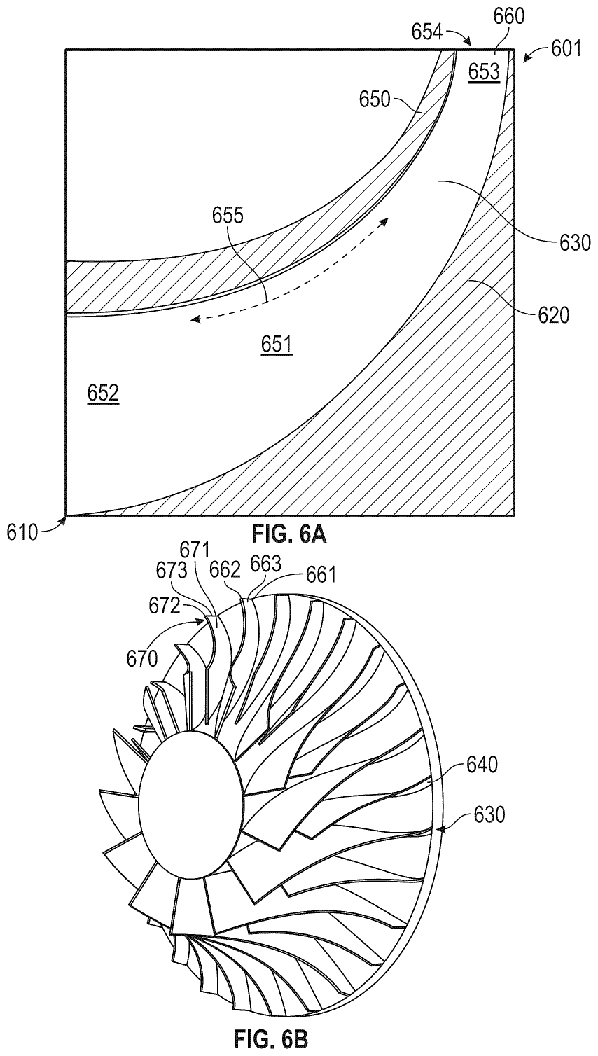

With reference back to FIGS. 1 and 2 and with additional reference to FIGS. 6A and 6B, a centrifugal compressor 601 of an aircraft gas turbine engine, such as the centrifugal compressor 15 of the gas turbine engine 10 of FIG. 1, is provided. The centrifugal compressor 601 includes an impeller 610. The impeller 610 includes an impeller hub 620, impeller main vanes 630, impeller splitter vanes 640 and an impeller shroud 650. The impeller shroud 650 surrounds the impeller hub 620 and surrounds the impeller main vanes 630 and the impeller splitter vanes 640 to form a flow path 651 from an inducer portion 652 at an upstream side of the impeller 610 to an exducer portion 653 at an impeller exit 654.

The impeller main vanes 630 extend from the inducer portion 652 to the exducer portion 653. The impeller splitter vanes 640 are interleaved with the impeller main vanes 630 and extend to the exducer portion 653 from an impeller mid-point. In accordance with embodiments, the impeller mid-point can be defined as an impeller knee 655, which is interposed between the inducer portion 652 and the exducer portion 653 and which is characterized as being a range of locations where the flow path 651 changes from a predominantly axial direction to a predominantly radial direction.

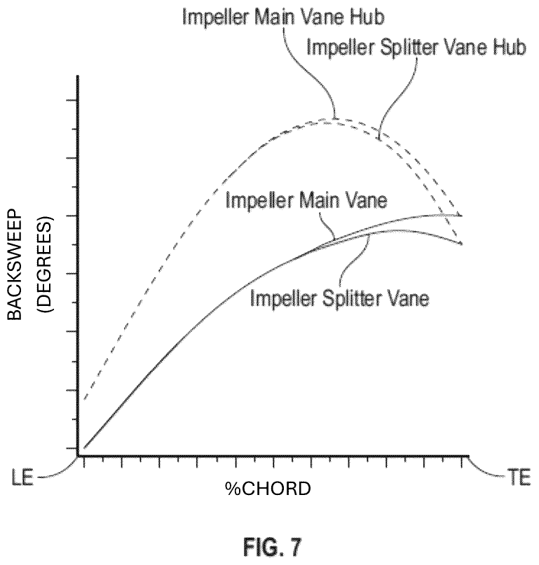

With continued reference to FIGS. 6A and 6B and with additional reference to FIG. 7, each of the impeller main vanes 630 includes, at the impeller exit 654, a trailing edge 660 and each of the impeller splitter vanes 640 includes, at the impeller exit 654, a trailing edge 670. The trailing edge 660 of each of the impeller main vanes 630 includes a hub-side trailing edge portion 661, which is proximate or adjacent to the impeller hub 620, a shroud-side trailing edge portion 662, which is proximate to and displaced from the impeller shroud 650 and a central trailing edge portion 663 that is interposed between the hub-side trailing edge portion 661 and the shroud-side trailing edge portion 662. The trailing edge 670 of each of the impeller splitter vanes 640 includes a hub-side trailing edge portion 671, which is proximate or adjacent to the impeller hub 620, a shroud-side trailing edge portion 672, which is proximate to and displaced from the impeller shroud 650 and a central trailing edge portion 673 that is interposed between the hub-side trailing edge portion 671 and the shroud-side trailing edge portion 672.

For one or more pairs of the impeller main vanes 630 and the impeller splitter vanes 640, the trailing edge 670 of the splitter vane 640 exhibits backsweep of a first degree and a same backsweep at the hub-side trailing edge portion 671 and at the shroud-side trailing edge portion 672 and the trailing edge 660 of the impeller main vane 630 exhibits backsweep of a second degree and a same backsweep at the hub-side trailing edge portion 661 and at the shroud-side trailing edge portion 662.

In accordance with embodiments and as shown in FIG. 7, for the one or more pairs of the impeller main vanes 630 and the impeller splitter vanes 640, the backsweep of the first degree exhibited by the trailing edge 670 of the impeller splitter vane 640 can be variable but in any case differs from the backsweep of the second degree exhibited by the trailing edge 660 of the impeller main vane 630 by about 5 degrees in absolute value and, more particularly, for the one or more pairs of the impeller main vanes 630 and the impeller splitter vanes 640, the backsweep of the first degree exhibited by the trailing edge 670 of the impeller splitter vane 640 can be variable but in any case exceeds the backsweep of the second degree exhibited by the trailing edge 660 of the impeller main vane 630 (i.e., from about 50%-70% chord to 100% chord). In an exemplary case, for the one or more pairs of the impeller main vanes 630 and the impeller splitter vanes 640, an angle of the backsweep of the first degree exhibited by the trailing edge 670 of the impeller splitter vane 640 is about −25 degrees and an angle of the backsweep of the second degree exhibited by the trailing edge 660 of the impeller main vane 630 is about −20 degrees. In at least one or more cases, the backsweep of the first degree exhibited by the trailing edge 670 of each of the impeller splitter vanes 640 differs from the backsweep of the second degree exhibited by the trailing edge 660 of each of the impeller main vane 630 by about 5 degrees in absolute value and, more particularly, the backsweep of the first degree exhibited by the trailing edge 670 of each of the impeller splitter vanes 640 exceeds the backsweep of the second degree exhibited by the trailing edge 660 of each of the impeller main vane 630 (i.e., from about 50%-70% chord to 100% chord).

Technical effects and benefits of the features described herein are the provision of an impeller of a centrifugal compressor with a modified impeller exit blade angle or by altering splitter blade backsweep relative to main blade backsweep. In either or both cases, the modification(s) leads to improved exit flow conditions achieved by a flattened pressure profile that in turn result in improved diffuser performance.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A centrifugal compressor of an aircraft gas turbine engine, the centrifugal compressor comprising:
an impeller comprising a hub, main and splitter vanes and a shroud surrounding the hub and the main and splitter vanes to form a flow path from an inducer portion at an upstream side of the impeller to an exducer portion at an impeller exit,
the main vanes extending from the inducer portion to the exducer portion and the splitter vanes being interleaved with the main vanes and extending to the exducer portion from an impeller mid-point, and
each main and splitter vane comprising, at the impeller exit, a trailing edge, and, for one or more pairs of main and splitter vanes:
the trailing edge of the splitter vane exhibits backsweep of a first degree, and
the trailing edge of the main vane exhibits backsweep of a second degree which differs in value from the backsweep of the first degree.

2. The centrifugal compressor according to claim 1, wherein the impeller mid-point is defined as an impeller knee, which is interposed between the inducer and exducer portions.

3. The centrifugal compressor according to claim 1, wherein:
the trailing edge of the main vane of the one or more pairs of main and splitter vanes comprises a main vane hub-side trailing edge portion, which is adjacent to the hub, a main vane shroud-side trailing edge portion, which is displaced from the shroud, and a main vane central trailing edge portion interposed between the main vane hub-side trailing edge portion and the main vane shroud-side trailing edge portion, and
the trailing edge of the splitter vane of the one or more pairs of main and splitter vanes comprises a splitter vane hub-side trailing edge portion, which is adjacent to the hub, a splitter vane shroud-side trailing edge portion, which is displaced from the shroud, and a splitter vane central trailing edge portion interposed between the splitter vane hub-side trailing edge portion and the splitter vane shroud-side trailing edge portion.

4. The centrifugal compressor according to claim 3, wherein:
the trailing edge of the main vane of the one or more pairs of main and splitter vanes exhibits a same backsweep at the main vane hub-side trailing edge portion and at the main vane shroud-side trailing edge portion, and
the trailing edge of the splitter vane of the one or more pairs of main and splitter vanes exhibits a same backsweep at the splitter vane hub-side trailing edge portion and at the splitter vane shroud-side trailing edge portion.

5. The centrifugal compressor according to claim 1, wherein, for the one or more pairs of main and splitter vanes, the backsweep of the first degree exhibited by the trailing edge of the splitter vane differs in value from the backsweep of the second degree exhibited by the trailing edge of the main vane by about 5 degrees.

6. The centrifugal compressor according to claim 1, wherein, for the one or more pairs of main and splitter vanes, an absolute value of a value of the backsweep of the first degree exhibited by the trailing edge of the splitter vane exceeds an absolute value of a value of the backsweep of the second degree exhibited by the trailing edge of the main vane.

7. (canceled)

8. The centrifugal compressor according to claim 1, wherein, for the one or more pairs of main and splitter vanes, an absolute value of a value of the backsweep of the first degree exhibited by the trailing edge of the splitter vane exceeds an absolute value of a value of the backsweep of the second degree exhibited by the trailing edge of the main vane from 50% chord to 100% chord.

9. The centrifugal compressor according to claim 1, wherein, for the one or more pairs of main and splitter vanes, a value of the backsweep of the first degree exhibited by the trailing edge of the splitter vane is variable from one splitter vane to another.

10. A centrifugal compressor of an aircraft gas turbine engine, the centrifugal compressor comprising:
an impeller comprising a hub, main and splitter vanes and a shroud surrounding the hub and the main and splitter vanes to form a flow path from an inducer portion at an upstream side of the impeller to an exducer portion at an impeller exit,
the main vanes extending from the inducer portion to the exducer portion and the splitter vanes being interleaved with the main vanes and extending to the exducer portion from an impeller mid-point, and
each main and splitter vane comprising, at the impeller exit, a trailing edge, and:
the trailing edges of the splitter vanes exhibit backsweep of a first degree, and
the trailing edges of the main vanes exhibit backsweep of a second degree.

11. The centrifugal compressor according to claim 10, wherein the impeller mid-point is defined as an impeller knee, which is interposed between the inducer and exducer portions.

12. The centrifugal compressor according to claim 10, wherein:
each of the trailing edges of the main vanes comprises a hub-side trailing edge portion, which is adjacent to the hub, a shroud-side trailing edge portion, which is displaced from the shroud, and a central trailing edge portion interposed between the hub-side trailing edge portion and the shroud-side trailing edge portion, and
each of the trailing edges of the splitter vane comprises a hub-side trailing edge portion, which is adjacent to the hub, a shroud-side trailing edge portion, which is displaced from the shroud, and a central trailing edge portion interposed between the hub-side trailing edge portion and the shroud-side trailing edge portion.

13. The centrifugal compressor according to claim 12, wherein:
each of the trailing edges of the main vanes exhibits a same backsweep at the hub-side trailing edge portion and at the shroud-side trailing edge portion, and
each of the trailing edges of the splitter vanes exhibits a same backsweep at the hub-side trailing edge portion and at the shroud-side trailing edge portion.

14. The centrifugal compressor according to claim 10, wherein the backsweep of the first degree exhibited by the trailing edges of the splitter vanes differs from the backsweep of the second degree exhibited by the trailing edges of the main vanes by about 5 degrees.

15. The centrifugal compressor according to claim 10, wherein the backsweep of the first degree exhibited by the trailing edges of the splitter vanes exceeds the backsweep of the second degree exhibited by the trailing edges of the main vanes.

16. (canceled)

17. The centrifugal compressor according to claim 10, wherein the backsweep of the first degree exhibited by the trailing edges of the splitter vanes exceeds the backsweep of the second degree exhibited by the trailing edges of the main vanes from about 50%-70% chord to 100% chord.

18. The centrifugal compressor according to claim 10, wherein the backsweep of the first degree exhibited by the trailing edges of the splitter vanes is variable from one splitter vane to another.

19. An impeller of a centrifugal compressor of an aircraft gas turbine engine, the impeller comprising:
a hub;
main vanes;
splitter vanes; and
a shroud surrounding the hub and the main and splitter vanes to form a flow path from an inducer portion at an upstream side of the impeller to an exducer portion at an impeller exit,
the main vanes extending from the inducer portion to the exducer portion and the splitter vanes being interleaved with the main vanes and extending to the exducer portion from an impeller mid-point, and
each main and splitter vane comprising, at the impeller exit, a trailing edge, and, for one or more pairs of main and splitter vanes, the trailing edge of the splitter vane exhibits greater backsweep than the trailing edge of the main vane.

20. The impeller according to claim 19, wherein each of the trailing edges of each of the splitter vanes exhibits greater backsweep than each of the trailing edges of each of the main vanes.
